(19) United States
(12) Patent Application Publication
(10) Pub. No.: US 2021/0087839 A1
(43) Pub. Date: Mar. 25, 2021

(54) APPARATUS AND SYSTEM FOR USE IN CONSTRUCTION TO ASSIST IN SUPPORTING SUSPENDED CONCRETE

(71) Applicants: Keith Anthony CALLANAN, Queensland (AU); Eamus Paul COOTE, Queensland (AU)

(72) Inventors: Keith Anthony CALLANAN, Queensland (AU); Eamus Paul COOTE, Queensland (AU)

(21) Appl. No.: 16/963,402

(22) PCT Filed: Jan. 21, 2019
(86) PCT No.: PCT/IB2019/050486

§ 371 Date: Jul. 20, 2020

(30) Foreign Application Priority Data
Jan. 21, 2018 (AU) 2018900187

(51) Int. Cl. E04G 25/04; E04G 11/48

(52) U.S. Cl. CPC E04G 25/04; E04G 2025/006; E04G 11/483; E04G 11/486

(57) ABSTRACT

An apparatus for use in construction to assist in the support of suspended concrete during at least a curing phase of the concrete. The apparatus comprising: a base member, a support member coupled to the base member and moveable relative to the base member between a first relative position (“first position”) and a second relative position (“second position”), a biasing mechanism operatively coupled to the support member to bias the support member toward the second position, and a preloading mechanism operatively coupled to the support member to releasably lock the support member in a preloaded position relative to the base member at or proximal to the first position.

### FIELD OF THE INVENTION

The present invention relates to a system and apparatus for use in construction to provide assistive support to suspended concrete slabs.

### BACKGROUND TO THE INVENTION

In construction, the process of forming elevated floors or ceilings in buildings involves pouring concrete into formwork, suspending the concrete and allowing the concrete to cure to form the floor or ceiling slabs. The formwork may be initially supported in an elevated position by any number of methods, including the use of support props. It is typically desirable to remove the formwork once the concrete hardens to a sufficient degree and continues to cure, so the formwork can be reused elsewhere. In this case, the support props are maintained in position to support the concrete for the remainder of the curing process. The support props are held tightly between the curing concrete and a supporting surface underneath (such as the floor of a lower level) during these initial stages of curing.

In most ceiling and floor constructions, reinforced, pre-stressed concrete is used. One method of pre-stressing concrete is post tensioning. This involves the positioning of tensioning tendons across the formwork (preferably in a pre-stressed manner) before concrete is poured, and then tensioning and anchoring the tendons to the periphery of the concrete once it has hardened to a sufficient degree.

Pre-stressed concrete contracts as it fully cures. As such, if the elevated concrete is supported by support props held tightly against the concrete, then as the concrete cures it will move away from the support surface of each prop. This will loosen the connection between the concrete and support prop and in most cases the contact between the support prop and concrete will be lost before the end of the curing process. Firstly, this can cause the prop to lose balance and fall. Support props are generally long, heavy members made of heavy weight steel or similar strong, rigid materials. As such, the loosening of the connection between the support prop and the concrete presents a serious safety hazard to workers and other personnel. In a typical construction site, there may be hundreds of props distributed across the floor to provide support for multiple slabs further exacerbating this safety issue. Also, the loosening of the connection also means the concrete is no longer being sufficiently supported during the entire curing process, leading to potential damage or weakening of the concrete.

Efforts have been made to alleviate these issues. For example, one technique used in construction to reduce the safety risk is to suspend ropes between walls for catching falling props. This technique often leads to the creation of safety paths within which the workers and personnel are encouraged to walk. The process of suspending ropes can be very time consuming and laborious. Also, this method does not solve the issue of losing support during the final stages of curing and having safety zone restrictions is frustrating to workers and personnel who want to navigate freely through the site.

Another technique used involves screwing the support surface of each prop to the concrete. But this technique also comes with its own problems. As the concrete contracts the prop will be pulled up and lifted with it. This prevents the prop from falling but can damage the concrete and is a known cause for concrete cancer, for example. The process of screwing the prop to the concrete slab is also laborious and time consuming, especially when multiple props are required to support a single slab. Removing the screws afterwards can also damage the concrete. Finally, once the prop is lifted, it is no longer supporting the concrete and instead applying a load during the final stages of curing which contradicts the intended purpose. Sometimes, workers are required to place another support block underneath the lifted prop to maintain support, but again this is a time consuming task that cannot be performed efficiently, meaning support to the concrete slab is inconsistent and non-optimal.

Another example is the load cell device shown in AU603455. The load cell has a spring loaded plate that can be bolted onto the top of a support prop to bias the plate toward the concrete and maintain contact during the curing phase. The process of bolting is still relatively cumbersome and time consuming, which limits the uptake of this device in industry. Additionally, the structure of the device does not allow for a large range of motion relative to its size which limits its compactness/portability.

It is an object of the present invention to provide an improved device and method that ameliorates at least some of the shortcomings of the existing systems and methods used to support curing elevated concrete slabs in construction as described above, or to at least provide the public with a useful choice.

### SUMMARY OF THE INVENTION

In one aspect the invention may broadly be said to consist of an apparatus for use in construction to assist in the support of suspended concrete during at least a curing phase of the concrete, the apparatus comprising:
a base member;
a support member coupled to the base member and moveable relative to the base member between a first relative position (“first position”) and a second relative position (“second position”);
a biasing mechanism operatively coupled to the support member to bias the support member toward the second position; and
a preloading mechanism operatively coupled to the support member to releasably lock the support member in a preloaded position relative to the base member at or proximal to the first position.

Preferably the first position is a retracted position in which the support member is relatively proximal to the base member and the second position is an extended position in which the support member is relatively distal to the base member

In some embodiments the preloaded position is at the fully retracted position of the support member. In other embodiments, the preloaded position is proximal to the fully retracted position.

In a preferred embodiment, the preloading mechanism comprises at least one pin coupled to the support member and releasably engageable with the base member, to thereby engage the base member in the preloaded position. A pair of pins may be located on either side of the support member. In some embodiments, each pin may be coupled to the base member and releasably engageable with the support member.

Preferably each pin is moveable between a first relative position (“preloading position”) in which the pin engages the base member and support member to lock the support member in the preloaded position relative to the base member, and a second position (“non-preloading position”) in which the pin disengages the base member or support member to enable movement of the support member away from the preloaded position relative to the base member. Each pin may engage a corresponding recess, aperture or formation in an underside of the base member to releasably couple the base member in the preloading position.

Preferably each pin is axially moveable between the preloading position and the non-preloading position.

Preferably each pin may be lockable in the preloading position and/or may be lockable in the non-preloading position. For example, each pin may comprise one or more lateral protrusions configured to cooperate with a corresponding channel fixed or integral to the support member (or base member), and wherein movement of the pin between the pre-loading and non-preloading positions is enabled when the protrusion(s) is(are) moved into alignment with the corresponding channel, and prevented when protrusion(s) is(are) moved out of alignment with the corresponding channel. Each pin may be rotatable or otherwise moveable between a first released position in which the protrusion(s) and channel are aligned to enable movement between the pre-loading and non-preloading positions, and a second locked position in which the protrusion(s) and channel are misaligned to substantially inhibit movement between the preloading and non-preloading positions. Preferably the pin is rotatable or otherwise moveable into the second locked position only when the pin is in the non-preloading position.

Preferably each pin is biased toward the preloading position. For example, each pin may be biased via a compression spring of the preloading mechanism.

Preferably each pin is removably coupled to the support member (or base member). For example, each pin may be threadably coupled to the support member (or base member). In other embodiments each pin may be integrally formed with the support member or base member.

Preferably the support member is linearly moveable relative to the base member between the first position and the second position.

In some embodiments the biasing mechanism comprises a resilient member. The resilient member may be made from a metal or other resilient material. Preferably the resilient member is substantially stiff to provide a sufficient support force to the concrete during curing. Preferably the resilient member is a helical, compression spring.

Preferably compression of the spring causes the support member to move toward the first position and relaxation of the spring causes the support member to move toward the second position. The vice versa arrangement may be implemented in alternative embodiments.

In some embodiments the biasing mechanism comprises an electromagnetic actuator, a pneumatic actuator and/or a hydraulic actuator acting on the support member.

Preferably the support member comprises a support plate having a support surface. Preferably the support surface comprises a substantially planar envelope. The support surface may comprise indentations or grips to increase the frictional coefficient of the surface with the suspended concrete structure.

Preferably the base member is configured to couple a support prop in situ.

Preferably the base member is configured to releasably couple a support prop in situ.

Preferably the base member is configured to engage a corresponding support plate at an end of the support prop, in situ.

Preferably the base member comprise a base plate and central shaft extending laterally from the base plate, and wherein in situ, the central shaft is accommodated with an open end of the support prop and the base plate rests upon a support plate of the open end of the support prop.

Preferably the shaft is of sufficient length to remain within the open end of the support prop, in situ, when the support member is in the first position and when the support member is in the second position.

Preferably the shaft extends substantially orthogonally relative to the base plate.

Preferably the shaft is substantially hollow.

Preferably the shaft extends from an opposing side of the base plate relative to the support member.

Preferably the biasing member is accommodated within a substantially hollow central shaft of the base member.

Preferably the base member is axially moveable over a central axial rod of the support member.

Preferably the biasing mechanism comprises a compression spring coupled about the central axial rod of the support member and held in compression with one end against the support member and an opposing end against the base member.

Preferably the compression spring and the central axial rod extend within an axially aligned central hollow shaft of the base member.

Preferably the apparatus further comprises a guide mechanism configured to maintain axial alignment of the support member with the base member during operation.

Preferably the apparatus comprises a guide mechanism configured to substantially inhibit rotational movement of the support member relative to the base member during operation. Preferably rotational movement is inhibited about a substantially common axis of the base member and support member.

Preferably the support member comprises a central support plate and side plates extending laterally from the central support plate, the base member comprises a central base plate and side plates extending laterally from the central base plate, the guide mechanism comprises of a pair of guide ribs formed on either the lateral side plates of the support member or the lateral side plates of the base member and a corresponding pair of guide channels formed on the other of the lateral side plates of the support member or the lateral side plates of the base member, and wherein the guide ribs are accommodated within the guide grooves to maintain axial alignment during movement of the support member relative to the base member.

Preferably the base member further comprises one or more anchoring points or apertures and the apparatus further comprises an anchoring device, such as a chain, configured to anchor the base member to a support prop in situ via the one or more anchoring points. The anchoring points may be distributed about the periphery of the base member. The anchoring points may be anchoring apertures configured to couple either end of a chain wound about the support prop column in situ.

In another aspect the invention may broadly be said to consist of a system for supporting a suspended concrete in construction during at least a curing phase of the concrete in which the concrete typically contracts, the system comprising:
a support prop having a base end and a support end; and
a support apparatus coupled to the support end or the base end of the prop having:
   a base member configured to couple the support end or the base end of the prop;
   a support member coupled to the base member, the support member being moveable relative to the base member between a first relative position (“first position”) and a second relative position (“second position”);
   a biasing mechanism operatively coupled to the support member to bias the support member toward the second position; and
   a preloading mechanism operatively coupled to the support member to releasably lock the support member in a preloaded position relative to the base member at or proximal to the first position.

Preferably the apparatus is configured to removably couple the support prop. Alternatively the apparatus may be integral to the support prop.

In another aspect the invention may broadly be said to consist of a support device for supporting suspended concrete in construction during at least a curing phase of the concrete in which the concrete typically contracts, the device comprising:
a longitudinal column having a base end and a support end and a main body between the base end and support end configured to span between a ground level and the elevated concrete in situ;
a support member at either the support end or the base end of the column that is moveable relative to the main body of the column between a first position and second position;
a biasing mechanism operatively coupled to the support member to bias the device toward the second position; and
a preloading mechanism operatively coupled to the support member to releasably lock the support member in a preloaded position relative to the base member at or proximal to the first position.

In another aspect, the present invention broadly consists in an apparatus for supporting suspended concrete during at least a curing phase, the apparatus comprising a biased support structure configured to support the concrete thereagainst and having at least one biasing member and at least one support surface, wherein each biasing member is configured to bias the at least one support surface toward the concrete in situ to maintain support of the concrete during the curing phase, and wherein the apparatus further comprises a preloading mechanism for locking the support surface in a preloaded position.

Preferably each support surface is moveable between a retracted position and an extended position and is biased by the associated biasing member toward the extended position.

Preferably the preloaded position is at or adjacent the retracted position.

Preferably each support surface is linearly moveable between the retracted position and the extended position.

In some embodiments the biased support structure comprises a single support surface. In alternative embodiments the biased support structure comprises two or more support surfaces.

In some embodiments the biased support structure comprises one biased support mechanism including a biasing member. In alternative embodiments the biased support structure comprises two or more biased support mechanisms, each mechanism including a biasing member. For example, the biased support structure may comprise a pair of biased support mechanisms on either side of the structure.

In some embodiments each biased support mechanism may comprise a telescoping pair of inner and outer sleeves that are configured to move relative to one another between a retracted position in which the inner and outer sleeves are substantially overlapping and an extended position in which the inner and outer sleeves are relatively less overlapping. Preferably the biasing member of each biasing mechanism is located within the telescoping pair of sleeves to enable relative movement therebetween. Preferably the pair of inner and outer sleeves are axially aligned. In some embodiments the outer sleeve is stationary and the inner sleeve is movable. In alternative embodiments the inner sleeve is stationary and the outer sleeve is movable. Preferably the inner or outer sleeve is linearly movable relative to the outer or inner sleeve, linearly along a common axis. Preferably an associated support surface is located at an end of the movable sleeve, such that the support surface is moveable between a retracted position and an extended position.

In some embodiments each biasing member may be a resilient member, such as a helical compression spring. In alternative embodiments each biasing member may comprise one or more actuators. The actuators may be electromagnetically, pneumatically or hydraulically operated for example.

In some embodiments the apparatus is configured to couple a support prop device and comprises a coupling mechanism configured to connect the apparatus to the support prop. Preferably the coupling mechanism is configured to connect the apparatus to an end of the support prop.

In some embodiments the coupling mechanism is a releasable coupling mechanism. In alternative embodiments the coupling mechanism is a fixed coupling mechanism.

In some embodiments the coupling mechanism is configured to cooperate with an open end or sleeve of the support prop. Preferably the coupling mechanism comprises an elongate member configured to be received within the open end or sleeve of the support prop. The coupling member may be loosely or tightly received within the open end or sleeve. The coupling member is preferably removably connectable to the open end or sleeve. Alternatively or in addition the coupling mechanism may comprise a clamp, one or more fasteners, adhesive, welding, a magnetic assembly or any other suitable mechanism for connecting two members known in the art.

In some embodiments the apparatus comprises a base member. Preferably the base member comprises an abutment face having a profile that corresponds with a profile of a surface at an end of the support prop, to thereby engage the abutment face with the surface of the support prop in situ. Preferably the abutment face is substantially planar. Preferably a coupling member extends laterally from the abutment face.

In some embodiments the apparatus may be integrally formed with the support prop.

In some embodiments the base member comprises a central body portion. Preferably the central body portion comprises a cavity for receiving an end of a support prop therein. Preferably the cavity is configured to accommodate a plate at an end of the support prop.

Preferably an elongate coupling member extends laterally from the central body portion within the cavity to couple the end of the support prop. The elongate coupling member may extend past the cavity.

In some embodiments the apparatus further comprises a guiding mechanism for maintaining axial alignment of the support surface with the support prop in situ and during movement between the fully retracted and fully extended positions. The guiding mechanism may comprise an axial guide rail and a corresponding axial guide channel on either side of the apparatus. Each guide rail may form part of a support plate and each guide channel may form part of a base member. Preferably, the guide mechanism also maintains rotational alignment of the support surface with the support prop.

In some embodiments the support surface comprises a substantially high frictional coefficient. The support surface may comprise high friction material applied thereto and/or one or more formations configured to increase the frictional coefficient of the surface.

In some embodiments the apparatus further comprises a mechanism for securing or anchoring the apparatus to the support prop. The apparatus may comprise one or more chains for example that can be attached to fixing points about the apparatus and tied around the support prop to secure the apparatus thereto.

In one aspect the invention may broadly be said to consist of an apparatus for use in construction to assist in the support of a moving load, the apparatus comprising:
a base member;
a support member coupled to the base member and moveable relative to the base member between a first relative position (“first position”) and a second relative position (“second position”);
a biasing mechanism operatively coupled to the support member to bias the support member toward the second position; and
a preloading mechanism operatively coupled to the support member to releasably lock the support member in a preloaded position relative to the base member at or proximal to the first position.

Any one or more of the above embodiments or preferred features described in relation to any one of the above aspects can be combined with any one or more of the other aspects.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

Number Ranges

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 is a perspective view from the top of a preferred form support apparatus of the invention;

FIG. 2 is a perspective view from the bottom of the support apparatus of FIG. 1;

FIG. 3 is an exploded perspective view of the support apparatus of FIG. 1;

FIG. 4 is a front cross-sectional view of the support apparatus of FIG. 1 in a neutral state;

FIG. 5 is a front view of the apparatus of FIG. 1 coupled to a support prop;

FIG. 6 is a front cross-sectional view of the support apparatus in FIG. 1 in situ and in a first supportive state, supporting a concrete slab in an initial stage of curing;

FIG. 7 is a front cross-sectional view of the support apparatus in FIG. 1 in situ and in a second supportive state, supporting a concrete slab in a final stage of curing;

FIG. 8 is a perspective view from the top of a modified version of the preferred form support apparatus of the invention;

FIG. 9 is a perspective view from the top of the modified version of the preferred form support apparatus of the invention in a preloaded state;

FIG. 10 is a close up view of the preloading mechanism of the apparatus of FIG. 8 in the preloaded state;

FIG. 11 is a close up view of the preloading mechanism of the apparatus of FIG. 8 in the released state;

FIG. 12 is a perspective exploded view of the apparatus of FIG. 8;

FIG. 13 is a perspective view of a preferred form pin of the preloading mechanism of the apparatus of FIG. 8 in the preloading state; and

FIG. 14 is a perspective view of the pin of FIG. 8 in the retracted state.

### DETAILED DESCRIPTION OF PREFERRED EMBODIMENTS

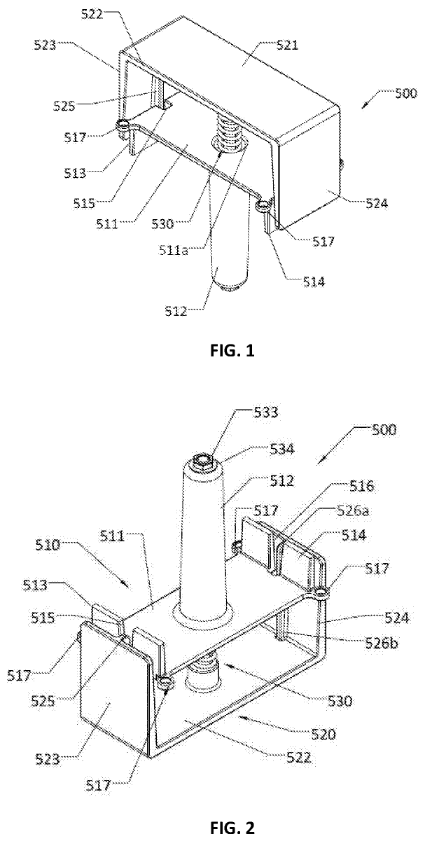

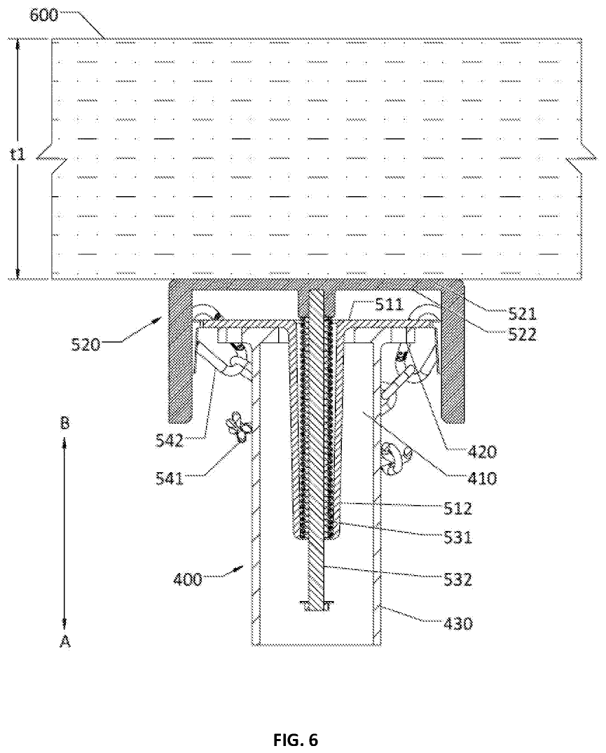

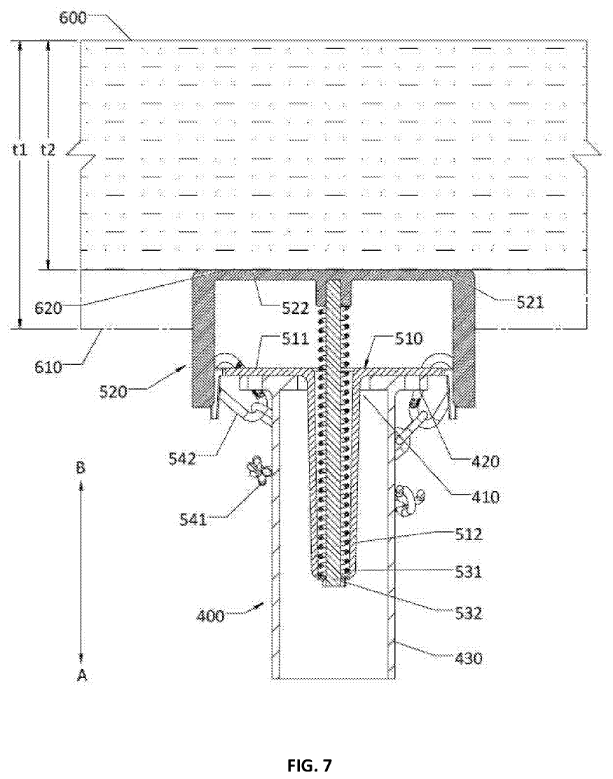

Referring to FIGS. 1-7, a first preferred embodiment of a concrete support apparatus 500 of the invention for use in conjunction with a support prop to provide assistive support to a suspended concrete slab or structure is shown. The apparatus comprises a support member 520 that is moveably coupled to a base member 510, such that the base member can move between a first relative position (shown in FIG. 6) and a second relative position (shown in FIG. 7). In this embodiment the first position is a retracted position in which the support member 520 is relatively proximal to the base member 510 and the second position is an extended position in which the support member 520 is relatively distal to the base member 510. The apparatus further comprises an actuating or movement mechanism 530 that enables relative movement between the support member 520 and the base member 510 and also moves the support member 520 toward the second relative position/extended position at least in situ and during operation (shown in FIG. 7). In this manner, the actuating mechanism biases the support member 520 toward the second position, in situ and during operation. In this embodiment, the actuating mechanism 530 comprise a resilient, biasing member 531, however it will be appreciated that other actuating mechanisms that bias the support member toward the second position may be used as will be described in further detail below. In this specification the phrase “biasing mechanism” is intended to mean an actuating mechanism that is configured to bias a member in a particular direction. The mechanism 530 is thus a biasing mechanism 530. The biasing mechanism may be structurally biased, such as a resilient spring or it may be controllably biased, such as in the case of an electromagnetic, pneumatic or hydraulic actuator. The extended position of the support member 520 is the neutral position of the support member in this embodiment, however this may not be the case in alternative configurations.

The support member 520 comprise a support surface 521 upon which the a suspended concrete slab or structure rests for assistive support during at least a substantial period of the curing process, and more preferably an entire period of the curing process. The apparatus 500 preferably also comprises a coupling mechanism configured to couple the support mechanism to a support prop 400 or other similar column support device. In alternative configurations, the support mechanism may be integral to the support prop or permanently fixed thereto. In this embodiment, the coupling mechanism forms part of the base member 510. However, as will be described later this is not necessarily the case in alternative configurations.

As shown in FIGS. 6 and 7 when appropriately installed between a concrete slab and a support prop, the support member 520 is forced toward or into the retracted position by the concrete slab during the initial stages of curing and is later moved toward the extended position by the biasing mechanism 530 as the concrete slab hardens, contracts and moves away from the support prop 400 (i.e. the thickness of the concrete reduces from t1 to t2). The biasing mechanism 530 of the apparatus 500 is configured to ensure there is substantially consistent physical support provided by the support prop 400 and support apparatus 500 to the suspended concrete slab 600 during the curing stage. In other words, the support surface 521 maintains substantially consistent physical contact with (i.e. is maintained in a flush position relative to) the concrete slab during the entire or at least a substantial period of the curing phase by action of the biasing mechanism 530.

In this embodiment, the support surface 521 is preferably substantially planar and comprises a sufficient surface area for contact and support. For example, the contact surface may comprise a surface area that is substantially similar or larger than the surface area of the contact face of the support prop plate 420. It will be appreciated however, that the invention is not intended to be limited to such surface area sizing as shown in the third and fourth embodiments for example. In some embodiments the support surface 521 may not be planar, however this is preferred for even distribution of support.

As mentioned, the apparatus 500 comprises a mechanism or device configured to couple the apparatus 500 to an end of a support prop 400 that is intended to be located adjacent the elevated concrete in situ. In this embodiment, the coupling mechanism comprises a base plate 511 of the base member 510, lateral side walls 513 and 514 extending from either side of the base plate 511, and a central shaft or sleeve 512 extending laterally from the base plate 511 in the same direction as the side walls. The sleeve 512 is substantially hollow and open at both ends 512a and 512b. The sleeve is axially aligned with a central aperture 511a of plate 511. As shown in FIGS. 6 and 7, the sleeve 512 is configured to be received and accommodated within a corresponding open and hollow end 410 of the support prop 400, in situ. This end 410 may be the end of the support prop configured to locate adjacent the suspended concrete in situ, or it may be the opposing end of the prop configured to locate adjacent the floor. In the latter case the support surface 521 is configured to engage the floor and bias the entire support prop toward the suspended concrete in situ. In this manner, the sleeve 512 enables the apparatus 500 to couple either end of a standard support prop so that it may be in the most convenient manner depending on the application. In addition, the sleeve 512 preferably comprises a diameter that enables it to couple support props of varying sizes (e.g. various types of support props having openings of various sizes). The sleeve 512 may be formed integrally as part of the base member 520 or otherwise formed separately and fixedly coupled to the base plate 511 about the central aperture 511a of the plate. It is preferred that the sleeve 510 is of sufficient length to remain within the open end 410 of the support prop in both the fully retracted and fully extended positions of the support member.

The base plate 511 and lateral side walls 513 and 514 form an open cavity or volume 515 which is configured to accommodate a substantially planar end plate 420 of the support prop 400 in situ. The plate 420 of the support prop preferably rests against the base plate 111 to substantially stabilise the apparatus 500 on and against the end 410 of the support prop 400. The lateral side walls 513 and 514 extending from either side of the central plate 111 provide a boundary for the cavity and enhance stabilisation of the apparatus on and against the support prop. The walls 513, 514 preferably comprise a length that is substantially the same or larger than the thickness of the support prop plate 420. The sleeve 512 preferably extends substantially orthogonally relative to and from the base plate 511. Similarly the lateral side walls 513 and 514 preferably extend substantially orthogonally relative to and from either side of the base plate 511. It will be appreciated that the side walls may alternatively extend about three or four sides of the base plate 511 to provide centring/stabilisation.

It is preferred that the apparatus 500 is configured to releasably couple the support prop to allow for replacement and maintenance for example. In alternative embodiments other coupling mechanisms may be employed. For example, one or more fasteners may be utilised instead or in addition to fasten the base member 510 to the corresponding end plate 420 of the support. In another alternative configuration, the apparatus may comprise a releasable clamping device which clamps against and/or about the end 410 of the support prop 400 in situ. In yet another alternative, a magnetic surface or material may be utilised in the base plate to promote engagement between the base member and support prop in situ. Other releasable coupling mechanisms that would be apparent to those skilled in the may also be incorporated and are not intended to be excluded from the scope of this invention. It will be appreciated that in some embodiments, any combination of one or more coupling mechanisms as described above may be incorporated in the apparatus 500. In yet another alternative embodiment, the base member 510 may be permanently coupled via permanent fasteners or any other suitable mechanism or otherwise integrally formed via welding with the end 410 of the support 400. In this latter construction the support prop body would form the base member 510 of apparatus 500.

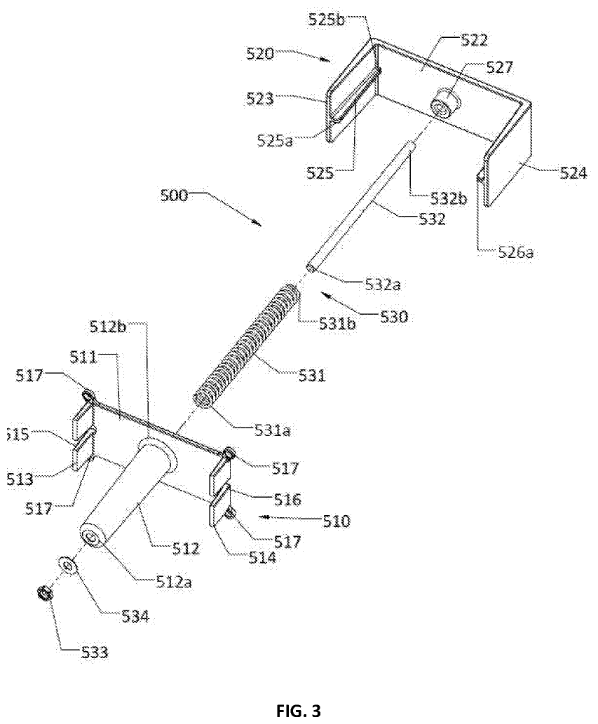

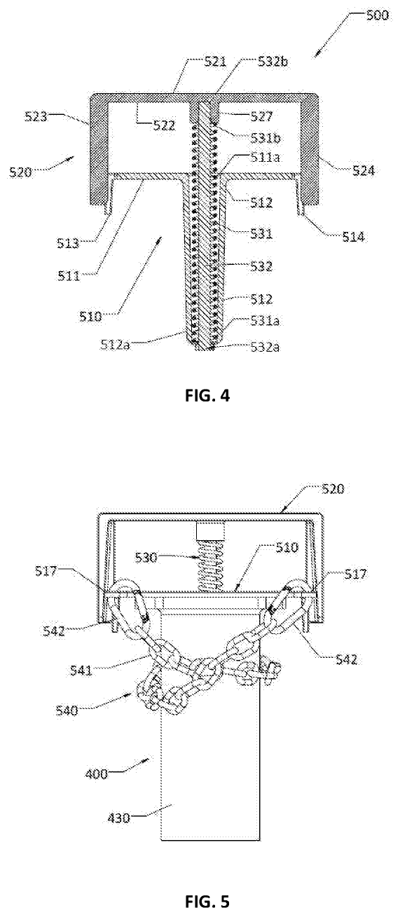

As shown in FIGS. 3 and 4, in this embodiment, the biasing mechanism 530 consists of a biasing member 531 that is resilient with a degree of stiffness sufficient to provide assistive support to suspended concrete. The resilient, biasing member 531 acts on the support member 520 to bias the surface 521 toward the fully extended position shown in FIG. 7. In this embodiment, the resilient member 531 is configured to locate within the sleeve 512 extending from the base member 510. It will be appreciated that any number of one or more resilient members may be provided and distributed about the base member to bias the support member 520 away from the base member 510. The number of resilient members may depend on the strength and/or resilience of each member and the weight that is to be supported for example.

The resilient member may be of any suitable or appropriate type for this application. In this embodiment, the resilient member 531 is in the form of a helical, compression spring. The compression spring preferably comprises substantially high stiffness and strength to enable suitable support for elevated concrete slabs used in construction, such as ceiling and/or floor slabs. As such it is preferably formed from a metal material, such as steel. As described above, in an assembled state of the apparatus, the helical compression spring 531 is located within the sleeve 512 with one end 531a being located against an abutment surface at end 512a of the sleeve and an opposing end 531b being located external to the sleeve 512. The end 531b is configured to engage and/or act on the support member 520 to bias the member 520 away from the base member 510 and toward the fully extended position shown in FIG. 7. For example, the end 531b may abut boss 527 of the support member 520.

The biasing mechanism 530 further comprises an axial, coupling rod or shaft 532. In the assembled state, the rod 532 extends axially through the spring and the coupling sleeve 512 of the base member 510 and engages the support member 520 at one end 532b. The rod 532 may be received within boss 527 of support member 520 at end 532b. The rod 532 also extends externally of the spring and the coupling sleeve 512 such that an opposing end 532a is exposed. A washer 534 and corresponding fastener 533, is coupled to the exposed end 532a of the rod 532 to provide a limiting stop or abutment. In this manner, the washer acts as an abutment that limits the relative movement between the support member and base member, by engaging the corresponding end 512a of the sleeve 512 when the support member 520 moves into the fully extracted position as shown in FIGS. 1, 2 and 7. The effective length of the rod, in situ, also defines the level of pre-compression applied to the spring which is application dependent. The nut may be threadably engaged onto the end of the rod.

In this embodiment the apparatus 500 may comprises a support surface 521 having a plurality of formations (not shown) that are configured to increase the frictional coefficient of the contact between the surface 521 and suspended concrete in situ. This arrangement enhances grip and frictional engagement with concrete slab 600 in situ. The formations may take on any shape, size or pattern that is necessary to achieve the desired level of grip. For example, the formations may consists of a plurality of protrusions arranged in a repeated pattern on an exterior side of the support member. The protrusions may each be of any polygonal shape in cross-section, such as a quadrilateral shape and the like. Channels may extend between the protrusions to create an irregular planar surface. The exterior surface 521 may also be substantially non-smooth and/or sufficiently rough to increase frictional engagement. The support surface 521 may be used in any one of the apparatus embodiments described in this specification.

As shown in FIGS. 1-3, in this embodiment the support member 520 of the apparatus 500 comprises a central support plate 522 that is configured to engage the concrete slab 500 in situ, and an opposing pair of side walls 523 and 524 extending laterally from either side of the central plate 522 away from the exterior support surface 521. The lateral side walls 523 and 524 are preferably integrally formed with the central plate section 522 but these may be separately formed and fixedly coupled thereto in alternative configurations. The lateral side walls 532 and 524 preferably extend substantially orthogonally relative to the central plate section 521, however other angles are possible. In particular, the lateral side walls 523 and 524 preferably extend substantially in parallel relative to the lateral side walls 513 and 514 of the base member 510 of the apparatus 500. Also, in this embodiment the lateral side walls 523 and 524 of the support member 520 are preferably located directly adjacent and on an exterior side of the lateral side walls 512 and 513 of the base member 510. It will be appreciated that these may be located internally of the side walls 512 and 513 in alternative configurations.

The apparatus 500 comprises a guide mechanism that is configured to axially align the support member 520 with the base member 510 in situ and during operation/movement. The guide mechanism is also configured to substantially reduce or mitigate relative lateral movement between the support member 520 and the base member 510 in directions that are substantially orthogonal to the intended directions of movement A and B (shown in FIGS. 6 and 7), in situ and during operation. It is also preferred that the guide mechanism substantially reduces or mitigates relative rotational movement between the support member 520 and the base member 510, about at least the common axis. In this manner, the guide mechanism ensures that an even distribution of support force is maintained on the suspended concrete as the support member moves relative to the base member, in situ. The support member 520 comprises a guide rail 525, 526 protruding respectively from either lateral side wall 523, 524 toward the corresponding lateral side wall 512, 513 of the base member 510. The lateral side walls 512 and 513 of the base member 510 comprise guide channels 515 and 516 configured to movably accommodate the guide rails 525 and 526 of the support member 520. The guide rails 525 and 526 and their corresponding guide channels 515 and 516 are substantially longitudinal and extend linearly in an axial direction that is substantially parallel to the axial directions of movement A-B of the apparatus 500. Each guide rail 525, 526 extends inwardly from an internal face of the respective lateral side wall 523, 524 toward the corresponding guide channel 515, 516 of the base member 510.

Each guide rail 525, 526 preferably extends from a terminal end of the respective lateral side wall 523, 524 that is distal from the central support plate 522 toward the central plate 522 and comprises of a length that is sufficient to enable movement of the support member 520 between the fully retracted and fully extended positions (i.e. the full range of motion of the apparatus 500). Each guide channel 515, 516 of the base member 510 comprises an open end at a terminal end of the respective lateral side wall 513, 514 that is distal from the central plate 511 of the base member 510. In this manner, each guide rail 525, 526 is permitted to move axially within the respective guide channel 515, 516 through the open end of the channel. In this embodiment, the guide rails 525 and 526 may provide a limit to the degree of relative displacement between the support member 520 and the base member 510, when the support member is in the extended position, by abutting with an inner surface of the central plate 511 of the base member 510. The guide rails 525 and 526 each comprise a depth that is gradually tapered. The end 525a and 525b of each rail that is distal from the central support plate 522 preferably comprises a higher depth relative to the end 525b, 526b of the rail that is proximal to the central support plate 522. However, in alternative configurations the depth of each rail may be constant along the entire length of the rail or oppositely tapered.

Each guide channel 515, 516 consists of a width that is substantially similar to the width of the received guide rail 525, 526 to thereby provide a snug fit that discourages or substantially prevents lateral movement of the guide rail within the channel along a first axis that is substantially orthogonal to the axial directions of movement A and B. Also, an interior surface of each lateral side wall 523, 524 of the support member 520 preferably extends directly adjacent and in contact with an exterior surface of the respective lateral side wall 513, 514 of the base member 510 to thereby discourage or substantially prevent lateral movement along a second axis that is substantially orthogonal to the axial directions of movement A and B and to the first axis. In this manner, during operation of the apparatus 500, as the support member 520 moves in directions A and B (shown in FIGS. 6 and 7) toward and away from the base member 510 respectively, the guide rails which are engaged with respective channels maintain axial alignment of the support member 520 with the base member 510.

It will be that many possible variations to this guiding mechanism exist. For example, the guide rails may be located on the base member and the guide channels on the support plate in some embodiments. The guide rails may extend through the central plate 511 of the base member 510. There may be multiple guide rails and corresponding channels on either side of the apparatus or there may be a single guide rail and corresponding channel. These and other variations that would be readily apparent to those skilled in the art are not intended to be excluded from the scope of this invention. The guide mechanism herein described may be used in any one of the apparatus embodiments described in this specification.

It will be appreciated that in some embodiments the apparatus 500 may alternatively or in addition consist of the centring sleeve for aiding in maintaining axial alignment between the support member and the base member as described with reference to the second embodiment.

Referring to FIG. 5, in this embodiment the apparatus 500 further comprises a mechanism 540 for securing or anchoring the apparatus 500 to the support prop 400 in situ. The mechanism may consist of any suitable devices and configuration and may be implemented in any one of the apparatus embodiments described in this specification. The securing or anchoring mechanism may comprise one or more chains 541 or cables or other lines that can be connected at either end to the apparatus 500 and tied around the prop support 400 to secure the device thereto. Each chain 540 may be releasably engaged with the apparatus 500 (via a carabiner 542 or other type of shackle device as is well known in the art for example) at one or both ends, or it may be fixedly engaged to the apparatus 500 at one end. The base member may comprises a plurality of fixing points or apertures 517 distributed about the periphery of the central plate 511 for releasably engaging with an end of a chain 541. Any suitable method of tying the chain about the prop support 400 may be used. For example, as shown in FIG. 5 in one method a chain may be wound about a neck 430 of the prop support 400 under the prop support head 420, and connected at either end to diagonally opposing fixing points 517, via a carabiner 542 or the like. Multiple chains 541 may be coupled to the base member 510 and the prop support 400 in this manner. It will be appreciated that one or more fixing points or apertures 517 may otherwise be located on either parts of the apparatus such as on the support member 520. This mechanism secures the apparatus 500 to the support prop 400 to avoid accidental disengagement which may result in damage to the apparatus 500 and/or injury to ground personnel. The securing or anchoring mechanism can be used in combination with any one of the embodiments herein described.

Referring now to FIGS. 6 and 7, as previously mentioned in the preferred embodiment the support member 520 is moveable between a fully retracted position in which it rests proximal to the central plate 511 of the base member 510 and the spring 531 is relatively compressed as shown in FIG. 6, and a fully extended position in which the support plate is substantially spaced and distal from the base member 510 and the spring 531 is compressed to a lesser degree as shown in FIG. 7. In the retracted position, the spring 531 is preferably substantially compressed and in the fully extended position the spring 531 is preferably in a neutral state, or close thereof. The degree of movement, or the distance between the fully retracted and fully extended positions of the support member 520, defines the degree of concrete contraction that is supported by the apparatus. For example, the distance between the fully retracted and fully extended positions may be between approximately 50 mm-500 mm, to thereby allow for contraction in the range of 50 m-500 mm. These ranges are only exemplary to provide context and are not intended to be limiting, however, a sufficient degree of movement is necessary in all preferred implementations to maintain support during a substantial or entire duration or period of the curing phase of the concrete. It will be appreciated that the degree of movement is dependent on the type of concrete used and is hence application dependent.

Referring to FIG. 6, once assembled, the apparatus 500 can be installed on an end 410 of a support prop 400. To achieve this, the sleeve 512 is inserted into the hollow end 410 of the prop and the central plate 511 of the base member 510 is located to rest on the stabilising plate 420 of the prop 400. The prop, with the apparatus installed, can then be positioned under the concrete slab to be supported such that the slab engages the support member 520 and forces it down toward the fully retracted position. The spring 531 compresses in this position. Referring to FIG. 7, as the slab 600 cures, it contracts and moves away from the initial position 610 and away from the support prop 400. The apparatus 500, by action of the biasing spring 531 maintains support by biasing the support member 520 toward the fully extended position and toward the concrete slab, such that physical contact at location 620 between the support member 520 and the concrete slab is maintained. As such, even in the final stages of curing shown in FIG. 7, contact between the support member 520 and the concrete slab is maintained which ensures the prop remains in position, and the slab remains sufficiently supported during the entire curing phase.

In some implementations the apparatus 500 may be coupled to an end of a support prop 400 that opposes the end 410. In other words, the apparatus 500 couples the end of the support prop that opposes the elevated concrete, or the end that is configured to locate on or adjacent a floor surface underneath the elevated concrete. In this manner, the apparatus 100 couples between the floor and the support prop 400 to thereby bias the entire support prop 400 toward the elevated concrete slab and continuously move the support prop plate 420 against the concrete slab 400 during the curing phase to maintain consistent physical contact between the plate 420 and the slab 600 in situ and use.

It will be appreciated that for the above described embodiment, one or more biasing mechanisms may be either structurally or controllably biased. Examples of a structurally biased mechanism include resilient members or magnetically biased constructions. These may continuously bias the support member toward the second position. Examples of controllably biased mechanisms include actuators that are electromagnetically, pneumatically or hydraulically operated and controlled, or any combination thereof. These may be operated to bias the support member toward the second position, only when the device is in situ for example and may also be operated to move the support member toward the first position when the device is initially installed. There may be any number of one or more types of biasing mechanisms necessary for achieving the desired level of support and biasing in the embodiments herein described.

Furthermore, the support surface may comprise any profile necessary for providing sufficient support and frictional engagement with the concrete or formwork to be supported in situ. The support surface may comprise multiple surfaces or a single surface.

The apparatus, including the base member, the sleeves and the support plate(s) are preferably formed from a substantially rigid material suited for the application of supporting concrete, such as steel. The helical spring may also be made from a substantially rigid material such as steel. Other materials may also be suitable for these parts and alternatively used as would be apparent to those skilled in the relative art.

In the preferred embodiment, the sleeve comprise a substantially cylindrical profile however it will be appreciated that other cross-sectional shapes may be used without departing from the scope of the invention.

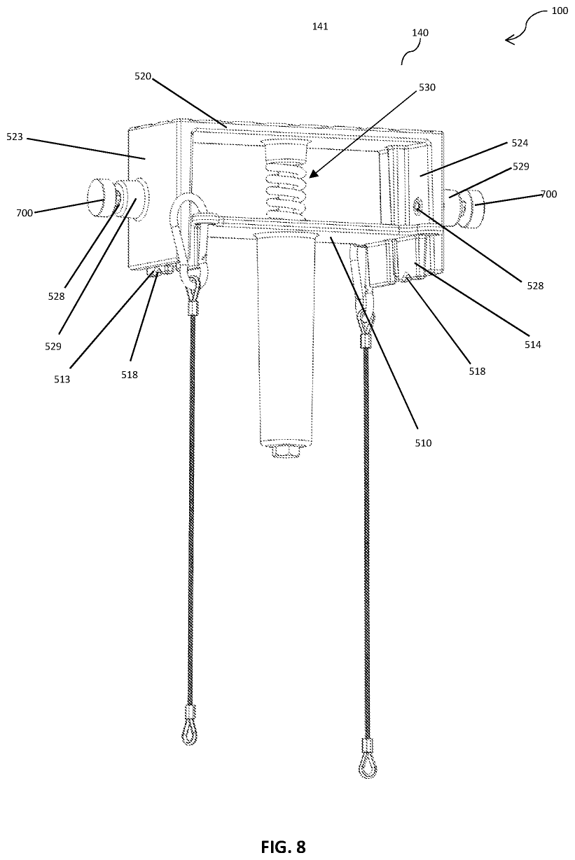

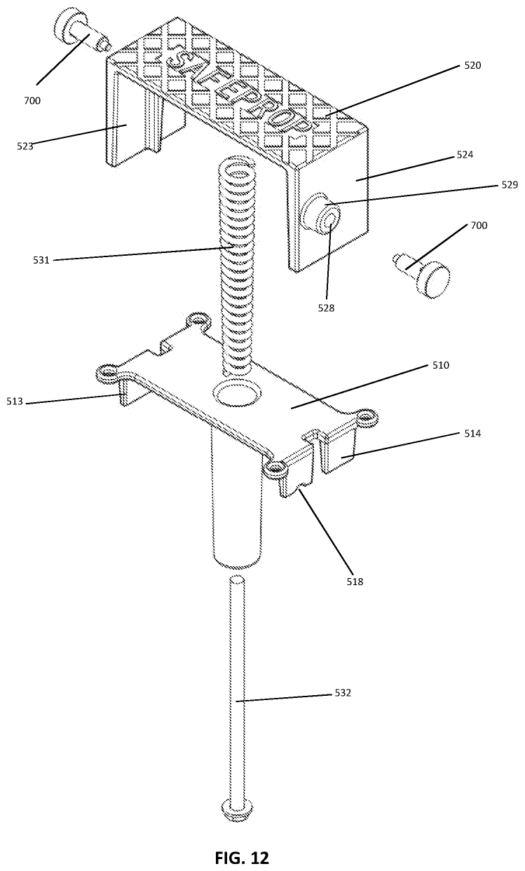

Referring now to FIGS. 8 to 12 a modification to the first embodiment is shown in which the concrete support apparatus 500 further comprises a mechanism for preloading and locking the biasing mechanism 530 and support member 520 in a retracted position to reduce the effort required to install the device, in situ. The mechanism may lock the support member 520 in a preloaded position that is partially retracted or, more preferably, fully retracted. In some embodiments, the preloading mechanism may be configured to lock the support member 520 relative to the base member 510 in one of multiple preloaded positions between the fully retracted and fully extended positions of the support member. In use, the mechanism can be used to preload the biasing mechanism 530 before installation, and to release the biasing mechanism after installation to allow the support platform to move toward the extracted position and assist in supporting curing concrete as described above.

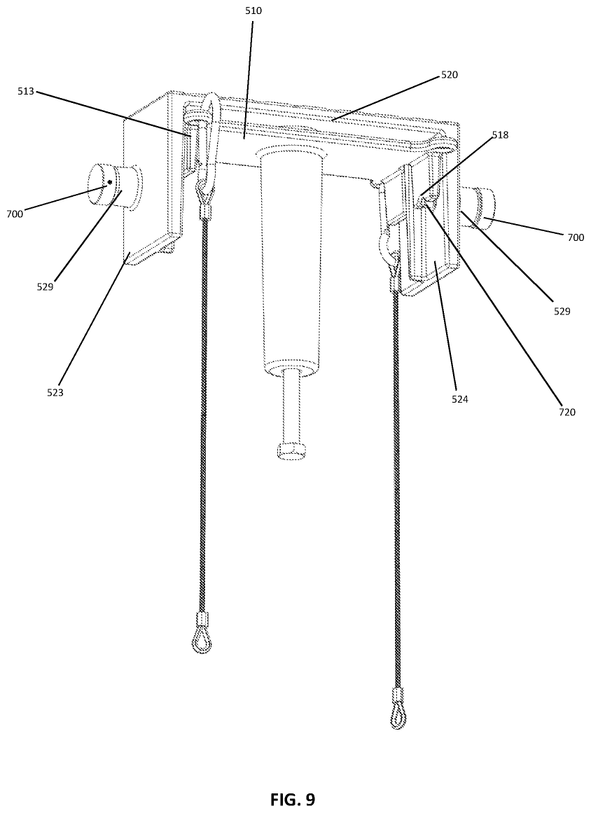

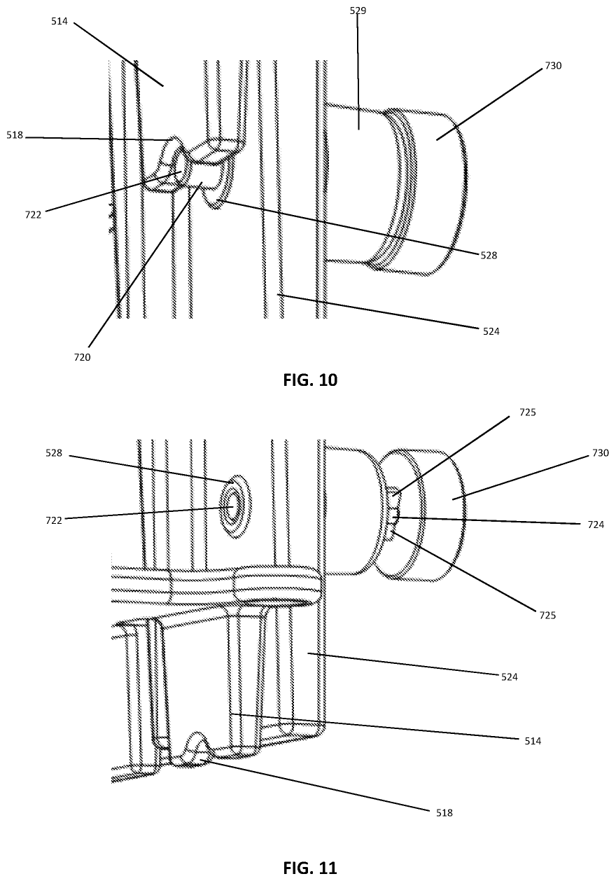

In this embodiment the preloading mechanism comprises a pair of pins 700 that are configured to releasably fix the support member 520 relative to the base member 510 in a desired position. Although a pair of pins 700 is described for this embodiment, alternative embodiments may utilise any number of one or more pins 700 to releasably fix the support member 520 relative to the base member 510. Each pin 700 fixes the support member 520 relative to the base member 510 by cooperating with an aperture 528 in the support member 520 and recess 518 in base member 510. Each aperture 528 may be formed through a corresponding boss 529 of the support member 520. However, this is optional. Each recess and aperture pair 518, 528 is formed in the corresponding wing sections 513, 523 or 514, 524 of the base and support members 510 and 520 respectively. The recess and aperture 518, 528 of each pair lie within a common axis that is substantially parallel to the axis of movement of the support member 520 (i.e. substantially parallel to the longitudinal axis of the apparatus 500 and to the directions of movement A and B). It is preferred that the recess 518 of at least one pair is formed in a terminal edge of the corresponding wing section 513 or 514 of the base member 510. However, it will be appreciated that the recess may alternatively be an aperture through the corresponding wing section 513 or 514 of the base member 510, preferably proximal to the terminal edge of the corresponding wing section. The corresponding aperture 528 of such pair(s) is formed through the wing section 523 or 524 of the support member 520 such that the aperture 528 is transversely aligned with the corresponding recess 518 when the support member 520 moves to a preloaded position (shown in FIGS. 9 and 10).

In this embodiment, the preloaded position is the fully retracted position in which the support plate 522 locates directly adjacent the base plate 511. It will be appreciated that in alternative embodiments the preloaded position may be anywhere between the fully retracted and the fully extended positions of the support member 520, but preferably closer to the fully retracted position. In situ, when the support member is moved into the preloaded position, e.g. the fully retracted position as in the embodiment, each pin 700 can be inserted through the corresponding aperture 528 in the support member 520 to extend through and under the corresponding recess 518 in the base member 510, thereby fixing the support member 520 relative to the base member 510 in the preloaded position. In this embodiment, a first aperture 518 is formed through one side of the support member and a second aperture is formed through the other side in a similar longitudinal position along the corresponding wing section. However, it will be appreciated that the longitudinal positions may be different in other embodiments. In some embodiments, there may be multiple longitudinally aligned apertures in the support member (or base member) on one or both sides to provide multiple preloading positions for the user to select from in use.

In use, to fix the support member 520 in the preloaded position, the support member 520 is first moved into the preloaded position in which the aperture and recess of each pair is aligned, and then a corresponding pin 700 is inserted into the apparatus such that it extends through the aperture and recess of each pair, thereby fixing the support member in the preloaded position. This reduces the effort required during installation of the apparatus 500 between the support prop and the load to be supported or the supporting surface/ground. Once the apparatus 500 is appropriately installed, each pin 700 can be removed from engagement with the corresponding recess 518 to decouple the support member 520 from the base member 510 and allow the biasing mechanism to move the support member 520 toward the extended position, thereby enabling the apparatus to aid in supporting the requisite load as previously described.

Each pin 700 may be of a simple construction including a longitudinal body that can be removably inserted through the corresponding aperture and recess, and a head that abuts the support member when inserted fully home to limit further insertion. It will be appreciated that in alternative embodiments, each pin is insertable through the base member first, such that the head abuts the base member when inserted fully home to limit further insertion.

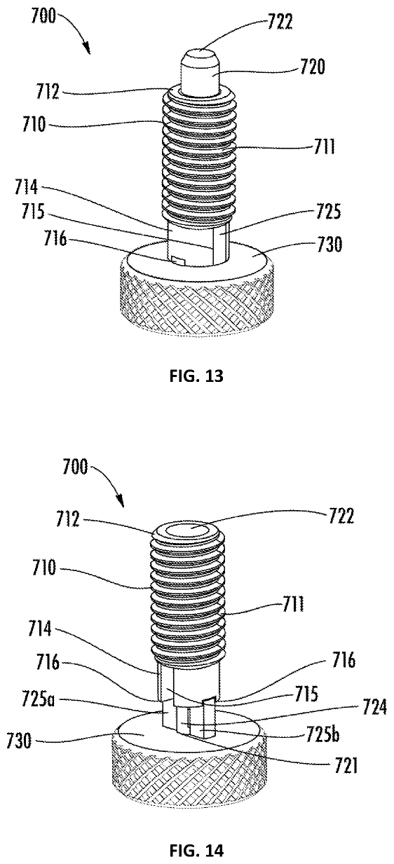

Referring to FIGS. 10, 11, 13 and 14, in this embodiment, each pin 700 is constructed so that it may rigidly couple the support member 520 to avoid having to fully remove the pin from the apparatus when the preloading mechanism is not in use. Each pin 700 comprises an outer body 710 and a longitudinal inner body 720 that is movably coupled to the outer body 710. The inner body 720 is moveable relative to the outer body 710 between a first relative position and second relative position. In the preferred embodiment the inner body 720 is axially moveable. The outer body 710 comprises an external thread 711 that engages with a corresponding internal thread (not shown) formed in the corresponding boss 529 of the support member 520. This enables the outer body 710 to fixedly couple the support member 520 in situ so that it is not necessary to remove the pin 700 from the support member 520 to engage and disengage the preloading mechanism. It will be appreciated that in alternative embodiments, other fixing mechanisms well known in the art, such as magnetic coupling, may be used for coupling the outer body to the support member. In some embodiments, the outer body 710 may be welded or otherwise integrally formed with the support member aperture 528 or boss 529 (or base member). The inner body 720 is axially moveable within the outer body 710 between a first axial position in which a terminal end 722 extends/protrudes beyond one end 712 of the outer body 720 (shown in FIGS. 10 and 13) and a second axial position (shown in FIGS. 11 and 14) in which the end 722 lies substantially flush with the end 712 of the outer body 720 or the end 722 locates within the outer body 710. In this manner, when the inner body is moved into the first axial position in situ, it extends through and abuts against the corresponding recess 518 of the base member to engage the preloading mechanism, and when the inner body 712 is moved into the second axial position it moves away from the recess to disengage the preloading mechanism.

The inner body 720 is preferably biased toward the first axial position via a corresponding internal biasing mechanism (not shown). In situ, this biases the pin 700 and preloading mechanism toward the engaged state (n which the inner body 712 is in the first axial position). For example, a spring may be coupled between the inner body 720 and outer body 710 to bias the inner body 720 toward the first position and the preloading mechanism toward the engaged state, in situ.

The inner body 720 is fixedly coupled to a head 730 of the pin 700 at an end 721 that opposes the terminal end 722. In situ, the head 730 locates at an opposing side of the corresponding aperture 528 of the support member 520 wing section to the side proximal to the base member 510 (as shown in FIGS. 10 and 11). In this embodiment, the inner body 720 further comprises a neck portion 724 adjacent the head 730 having one or more lateral protrusions or wings 725 extending radially therefrom. In this embodiment, a pair of opposing, lateral protrusions 725a, 725b are provided but it will be appreciated any number of one or more radially spaced, lateral protrusions may be provided without departing from the scope of the invention. A neck portion 714 of the outer body includes one or more recesses or cavities 715 that correspond to the profile of the protrusion(s) 725 of the inner body neck portion 724 for enabling axial movement of the inner body between the first and second axial positions.

The inner body 720 is also rotatable within the outer body 710 to move between a first rotatable position and a second rotatable position. In this manner, the neck 724 can be rotated in and out of alignment with the corresponding cavity 715 of the outer body 710, when the inner body is in the second axial position. For example, in a first rotational position (shown in FIGS. 10 and 13) the protrusions 725a, 725b of neck 724 are aligned with recesses 715 on either side of the outer body neck 714 (only one protrusion 725 and recess 715 are shown), thus allowing the inner body 710 to move toward and into the first axial position. In this state, the inner body is also locked from rotation toward the second rotational position, thereby locking the preloading mechanism in the engaged state. When the inner body is retracted into the second axial position such that the move away from corresponding recesses 715, the inner body is then allowed to rotate. When the inner body 712 is moved to the second axial position, in which the protrusions 725a, 725b are disengaged from the corresponding recesses 715, the inner body 712 may be rotated toward the second rotational position (shown in FIGS. 11 and 14) and out of alignment with corresponding recesses 715. This action locks the inner body in the second axial position and the preloading mechanism in the disengaged state, in situ. It is preferred that the neck portion 714 further comprises one or more notch(es) 716 formed at the terminal edge of neck portion 714. The notch(es) are radially spaced relative to the recesses 715, for engaging the protrusions 725 in the second rotatable position (as shown in FIG. 14). This feature is optional but preferred. It is preferred that a pair of notches 716 are provided on either side of the pair of recesses 715. Preferably the notches 716 are angled approximately orthogonally relative to the recesses 715. In this manner, in the second rotatable position the protrusions 725a, 725b are angled relative to the recesses 715. Preferably, but without limitation, the protrusions 725a, 725b are substantially orthogonal to the recesses 715 in this position. It will be appreciated that in some embodiment, the inner body may not be rotatably coupled to the outer body, but otherwise linearly moveably to align and misalign the neck 724 or protrusions 725 with the corresponding neck 714.

The preloading mechanism may further comprise one or more nuts and/or washers for securing each pin 700 to the corresponding support member aperture 528 and/or boss 529. In use, when each pin 700 is coupled to the respective aperture 528 and/or boss 529 of the support member, the following steps can be taken to engage and disengage the preloading mechanism. To engage the preloading mechanism, a user may rotate the inner body 720 of each pin 700 toward the first rotational position so that the neck 724 and protrusion(s) 725 move into alignment with the respective outer body recess(es) 715. This allows the inner body 720 to move axially relative to the outer body toward the first axial position, so that the terminal end 722 may protrude beyond the aperture 528. The internal biasing mechanism may facilitate in the movement of the inner body 712 toward the first axial position (shown in FIGS. 10 and 13). In this position, the terminal end 722 of the inner body of each pin 700 engages the respective recess 518 of the base member 510 to hold the support member 520 in a preloaded state relative to the base member 510. To disengage the preloading mechanism, a user may pull on the head 730 of each pin to move the inner body 720 into the second axial position relative to the outer body 710 (shown in FIGS. 11 and 14). In this axial position, the inner body 720 can be rotated into the second rotational position to force the neck 724 and protrusion(s) 725 out of alignment with the corresponding recess(es) 715, and optionally into corresponding notch(es) 716, thereby locking the inner body 712 in the second axial position and the preloading mechanism in the disengaged state. In the case where notch(es) 716 are provided, to return the inner body 720 into the first rotational position, the head 730 must first be pulled away from the outer body 711 so that the protrusion(s) 725 disengage the notch(es) thereby allowing rotation of the inner body 712 again.

It will be appreciated that other mechanisms for locking the preloading mechanism in the engaged and/or disengaged states may be utilised without departing from the scope of the invention as would be readily apparent to the skilled artisan. In some embodiments, each pin 700 may be fixedly coupled or integrally formed with the base member to releasably connect with the support member in the preloaded position and disconnect therefrom to disengage the preloading mechanism.

In alternative embodiments, other preloading mechanisms or devices may be used to lock the support member in a preloaded state/position relative to base member. For example, one or more clamps or other similar devices may be used to hold the support member in the preloaded position during installation. The clamp(s) may be released and/or removed after installation to allow the support member to move away from the preloaded position, in situ.

It will be appreciated that the apparatus of the present invention as described with reference to the above embodiments may be used in construction to assist in the support of any suspended moving load, and the invention is not intended to be limited to the preferred use of supporting suspended concrete.

The foregoing description of the invention includes preferred forms thereof. Modifications may be made thereto without departing from the scope of the invention as defined by the accompanying claims.

1. An apparatus for use in construction to assist in the support of suspended concrete during at least a curing phase of the concrete, the apparatus comprising:
a base member;
a support member coupled to the base member and moveable relative to the base member between a first relative position (“first position”) and a second relative position (“second position”);
a biasing mechanism operatively coupled to the support member to bias the support member toward the second position; and
a preloading mechanism operatively coupled to the support member to releasably lock the support member in a preloaded position relative to the base member at or proximal to the first position.

2. An apparatus as claimed in claim 1 wherein the first position is a retracted position in which the support member is relatively proximal to the base member and the second position is an extended position in which the support member is relatively distal to the base member.

3. An apparatus as claimed in claim 1 wherein the preloading mechanism comprises at least one pin coupled at a first end to one of the support member or base member and releasably engageable at an opposing, second end with the other of the support member or base member, to thereby engage the base member or support member in the preloaded position.

4. An apparatus as claimed in claim 3 wherein each pin is moveable between a first relative position (“preloading position”) in which the pin engages the base member and support member to lock the support member in the preloaded position relative to the base member, and a second position (“non-preloading position”) in which the pin disengages the base member or support member to enable movement of the support member away from the preloaded position relative to the base member.

5. An apparatus as claimed in claim 4 wherein each pin is axially moveable between the preloading position and the non-preloading position.

6. An apparatus as claimed in claim 4 wherein each pin is releasably lockable in the preloading position.

7. An apparatus as claimed in claim 4 wherein each pin is releasably lockable in the non-preloading position.

8. An apparatus as claimed in claim 4 wherein each pin is biased toward the preloading position.

9. An apparatus as claimed in claim 2 wherein each pin is removably coupled to one of the support member or base member at the first end.

10. (canceled)

11. An apparatus as claimed in claim 1, wherein the base member comprises a base plate configured to engage a corresponding support plate at an end of a support prop in situ.

12. An apparatus as claimed in claim 11 further comprising a shaft extending substantially centrally relative to the base plate and on an opposing side of the base plate to the support member to extend within an opening of the end of the support prop, in situ.

13. An apparatus as claimed in claim 12, wherein the shaft is substantially hollow.

14. An apparatus as claimed in claim 13, wherein the biasing mechanism comprises a spring accommodated within the hollow shaft.

15. An apparatus as claimed in claim 1, wherein the base member is configured to releasably couple a support prop in situ.

16. An apparatus as claimed in claim 1 further comprising a guide mechanism configured to maintain axial alignment of the support member and the base member along a common axis during operation of the apparatus.

17. An apparatus as claimed in claim 16, wherein the guide mechanism substantially inhibits relative rotational movement about the common axis between the support member and the base member.

18. An apparatus as claimed in claim 16, wherein one of the support member or the base member comprises at least one guide member and the other of the support member or the base member comprises at least one corresponding guide channel, and wherein each guide member is accommodated within the corresponding guide channel in situ to maintain axial alignment during movement of the support member relative to the base member.

19. An apparatus as claimed in claim 18, wherein each guide member extends from the support member and each guide channel is formed in the base member.

20. An apparatus as claimed in claim 18 comprising at least one pair of guide members and at least one pair of corresponding guide channels.

21. An apparatus for supporting suspended concrete during at least a curing phase, the apparatus comprising a biased support structure configured to support the concrete thereagainst and having at least one biasing member and at least one support surface, wherein each biasing member is configured to bias the at least one support surface toward the concrete in situ to maintain support of the concrete during the curing phase, and wherein the apparatus further comprises a preloading mechanism for locking the support surface in a preloaded position.
